(19) United States
(12) Patent Application Publication
(10) Pub. No.: US 2013/0223340 A1
(43) Pub. Date: Aug. 29, 2013

(54) APPARATUS AND METHOD FOR IDENTIFYING AVAILABLE ACCESS POINTS

(71) Applicant: Pantech Co., Ltd., (US)

(72) Inventor: Do Won JEONG, Seoul (KR)

(73) Assignee: Pantech Co., Ltd., Seoul (KR)

(21) Appl. No.: 13/740,605

(22) Filed: Jan. 14, 2013

(30) Foreign Application Priority Data
Feb. 24, 2012 (KR) 10-2012-0019235

(51) Int. Cl. H04W 48/16

(52) U.S. Cl. CPC H04W 48/16
USPC 370/328

(57) ABSTRACT

An apparatus to identify an available access point (AP) includes a communication unit to detect one or more APs located within a reference proximity from the apparatus, a determination unit to determine an available state of the detected AP, and a display unit to display an AP scan list including available state of the accessible AP. A method for identifying an available AP of a wireless local area network (LAN) terminal includes detecting APs located within a reference proximity of the wireless LAN terminal, determining an available state of at least one of the detected APs, and displaying an AP scan list including the available state of the AP.

### CROSS-REFERENCE TO RELATED APPLICATION

This application claims priority from and the benefit under 35 U.S.C. §119(a) of Korean Patent Application No. 10-2012-0019235, filed on Feb. 24, 2012, the entire disclosure of which is incorporated herein by reference for all purposes.

### BACKGROUND

1. Field

The present disclosure relates to an apparatus and a method for identifying one or more available access points (APs) of a wireless local area network (LAN) terminal.

2. Discussion of the Background

A wireless LAN refers to a wireless network environment, which supports local wireless communication among devices. Recently, a wireless LAN system based on Wireless Fidelity (Wi-Fi) with 802.11 communication standard has been manufactured and commercialized.

The Wi-Fi based wireless LAN system generally includes a wireless LAN terminal, which may connect to one or more Access Points (APs). The wireless LAN terminal may access a network, such as Internet, through an AP and perform data communication with various servers on the network.

A general AP connection process of the wireless LAN terminal is as follows.

First, the wireless LAN terminal performs a scanning operation to detect one or more APs that may be available for access and to generate an AP scan list, which may be displayed on a screen of the wireless LAN terminal. The APs that are located or installed within a certain range of distance from the wireless LAN terminal are detected by the wireless LAN terminal, which may be referred as detected APs.

In detail, the wireless LAN terminal receives beacon messages periodically broadcasted by APs located within a certain range of distance from a location of the wireless LAN terminal. The wireless LAN terminal obtains basic connection information of the AP from the received beacon messages. Then the wireless LAN terminal generates and displays an AP scan list using the basic connection information.

The basic connection information of the AP includes Service Set Identifier (SSID) of the AP, a supported communication speed, a security setting method, such as Wired Equivalent Privacy (WEP) and Wi-Fi Protected Access 2 (WPA2), a data encoding method and Received Signal Strength Indicator (RSSI) of a beacon message broadcasted from the AP. In addition, the AP scan list includes a plurality of rows of detected APs, of which the basic connection information is recorded or provided. Each row generally represents a line or an AP in the AP scan list. Rows where the basic connection information of the AP is recorded (hereinafter, referred to as ‘AP row’) are arranged according to a predetermined list order to configure the AP scan list.

After that, if a connection to a specific AP in the AP scan list is requested by a user, the wireless LAN terminal may perform a certification procedure for the specific AP to connect to the specific AP. In addition, the wireless LAN terminal may store basic connection information of the connected AP in an internal memory region.

Meanwhile, during a process of generating the AP scan list, the wireless LAN terminal may check the basic connection information of each AP recorded as an AP row of the AP scan list. If a specific AP in the AP scan list is determined to have a previous connection history with the wireless LAN terminal, the wireless LAN terminal may adjust its AP row rank to be a top rank or an upper rank in the AP scan list. The wireless LAN terminal may match the basic connection information of a detected AP in the AP scan list with basic connection information of previously connected APs to determine whether the detected AP corresponds to a previously connected AP.

In addition, the wireless LAN terminal may check the basic connection information of the APs recorded in the AP scan list and may adjust ranking of one or more of the APs included in the AP scan list according to the RSSI that may be included in the beacon message broadcasted from the AP. Generally, the wireless LAN terminal adjust the ranking of APs according to its distance to the respective APs, such that an AP located closer to the wireless LAN terminal may be ranked higher in the scan list. The change in ranking based on distance may be due to the RSSI of the beacon message received from an AP becoming stronger as the distance between the wireless LAN terminal and the AP becomes smaller.

If the AP scan list is displayed on a screen of the wireless LAN terminal, a user may attempt to connect the wireless LAN terminal to an AP that may have a higher rank in the AP scan list.

However, while an AP row in the AP scan list may display basic connection information of an AP corresponding to the AP row, it does not display availability or accessibility information of an AP, which may notify whether the AP is available for access.

An available or accessible AP may refer to an AP where the wireless LAN terminal may freely use a network, such as the Internet, after accessing or connecting to the network. For example, an AP operated by a communication service provider, to which the wireless LAN terminal subscribes, may be regarded as an available or accessible AP.

An unavailable or inaccessible AP may refer to an AP where the wireless LAN terminal may use a network, such as Internet, after performing a separate additional procedure, such as certification or payment, after accessing the network. For example, an AP operated by other communication service providers or an AP installed at a specific place, such as a hotel or an airport, may be regarded as an unavailable or inaccessible AP.

Therefore, when the wireless LAN terminal is located near an unavailable AP, the AP row corresponding to the unavailable AP is arranged at a top rank or an upper rank in the AP scan list. However, since the user may not know whether the AP is available, the user may attempt to connect to the AP even though the AP may be unavailable based on its rank in the AP scan list.

Therefore, even if the connection between the wireless LAN terminal and the unavailable AP corresponding to the top ranked AP row is successful, the wireless LAN terminal may access only a web server requesting certification or payment through the connected AP when the user execute a web browser installed at the wireless LAN terminal, which may prevent or obstruct the user from freely using the network.

In addition, in the related art, in order to sort out AP rows corresponding to available APs among the detected APs in the AP scan list, a user may need to connect the wireless LAN terminal to each AP included in the AP scan, and operate a web browser or the like installed at the wireless LAN terminal to check or determine whether the network may be freely used through the connected AP.

### SUMMARY

Exemplary embodiments of the present invention provide an apparatus to identify an access point (AP) of a wireless local area network (LAN) terminal.

Exemplary embodiments of the present invention also provide a method for identifying an AP of a wireless LAN terminal.

Additional features of the invention will be set forth in the following description, and in part will be apparent from the description, or may be learned from practice of the invention.

An exemplary embodiment of the present invention provides an apparatus to identify an available access point (AP) including a communication unit to detect one or more APs located within a reference proximity from the apparatus; a determination unit to determine an available state of the detected AP; and a display unit to display an AP scan list including available state of the accessible AP.

An exemplary embodiment of the present invention provides a method for identifying an available AP of a wireless local area network (LAN) terminal including detecting APs located within a reference proximity of the wireless LAN terminal; determining an available state of at least one of the detected APs; and displaying an AP scan list including the available state of the AP.

An exemplary embodiment of the present invention provides a method for identifying an available AP of a wireless LAN terminal including detecting APs located within a reference proximity of the wireless LAN terminal; connecting to an AP among the detected APs; transmitting a test communication to the AP; determining an available state of the AP based on the test communication; terminating the connection with the AP; and displaying an AP scan list including the available state of the AP.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings which are included to provide a further understanding of the invention and are incorporated in and constitute part of this specification, illustrate exemplary embodiments of the invention, and together with the description serve to explain the principles of the invention.

FIG. 1 is a block diagram illustrating an apparatus to identify an available AP of a wireless LAN terminal according to an exemplary embodiment of the present invention.

FIG. 2 is a reference view illustrating a header of a request signal according to an exemplary embodiment of the present invention.

FIG. 3 is a reference view illustrating a header of a response signal according to an exemplary embodiment of the present invention.

FIG. 4 is a reference view illustrating a communication state code included in the response signal according to an exemplary embodiment of the present invention.

FIG. 5 is a flowchart illustrating a method for scanning an AP in a wireless LAN terminal according to an exemplary embodiment of the present invention.

FIG. 6 is a reference view illustrating AP scan lists with available state information of APs included therein according to an exemplary embodiment of the present invention.

FIG. 7 is a flowchart illustrating an available state determining procedure of FIG. 5 according to an exemplary embodiment of the present invention.

FIG. 8 is a reference view illustrating AP scan lists with available state information of APs included therein according to an exemplary embodiment of the present invention.

FIG. 9 is a reference view illustrating AP scan lists with available state information of APs included therein according to an exemplary embodiment of the present invention.

FIG. 10 is a reference view illustrating AP scan lists with available state information of APs included therein according to an exemplary embodiment of the present invention.

FIG. 11 is a reference view illustrating AP scan lists with available state information of APs included therein according to an exemplary embodiment of the present invention.

FIG. 12 is a block diagram illustrating an apparatus to identify an available AP of a wireless LAN terminal according to an exemplary embodiment of the present invention.

FIG. 13 is a flowchart illustrating an available state determining procedure according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity.

It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Further, it will be understood that when an element is referred to as being “connected to” another element, it can be directly connected to the other element, or intervening elements may be present.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

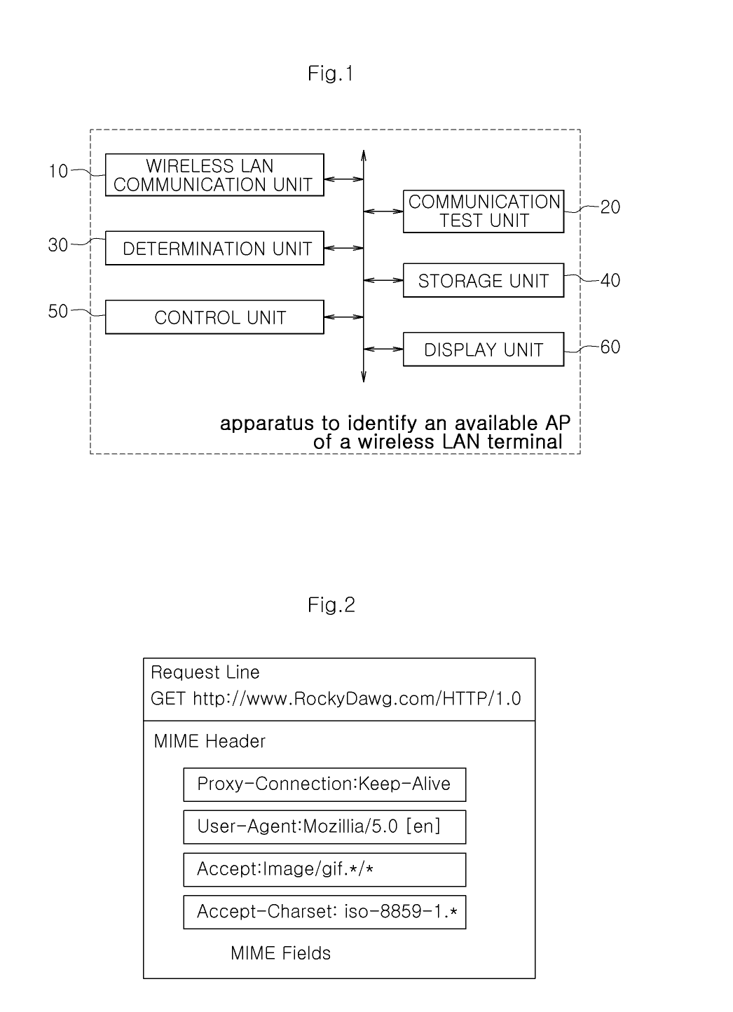

FIG. 1 is a block diagram illustrating an apparatus to identify an available access point (AP) of a wireless local area network (LAN) terminal according to an exemplary embodiment of the present invention.

Referring to FIG. 1, the apparatus to identify one or more APs of a wireless LAN terminal includes a wireless LAN communication unit 10, a communication test unit 20, a determination unit 30, a storage unit 40, a control unit 50 and a display unit 60.

The wireless LAN communication unit 10 may perform communication with an AP according to a control of the control unit 50 and may perform connection or disconnection to/from the AP.

In addition, the wireless LAN communication unit 10 may provide AP communication information to the control unit 50 according to an AP connection status, which may indicate a success status or a fail status.

The communication test unit 20 may perform test communication with a specific server on a network through the AP connected to the wireless LAN communication unit 10 according to the control of the control unit 50. The communication test unit 20 may store at least one of an internet protocol (IP) address of a specific server, a uniform resource locator (URL) address of a web page provided by the specific server, or the like in an internal memory region to perform test communication with the specific server. However, aspects of the invention are not limited thereto, such that an external memory may be used to store the respective information. The external memory may be accessed through a network or the like.

For example, the specific server may be a web server, which may allow ordinary connection through a network, to enable distributed data processing. The distributed data processing may be performed at a reference rate. Further, the specific server may have a large-capacity data storage space, and may be capable of bearing a large amount of communication traffic.

When performing test communication with the specific server, the communication test unit 20 may transmit a request signal for calling a web page provided by the specific server through the AP connected to the wireless LAN communication unit 10 and may receive a response signal from the specific server through the AP.

For example, the web page provided by the specific server may have a Hypertext Markup Language (HTML) document or image, which may be implemented through less than 10 signal transmissions between the communication test unit 20 and the specific server. Such a web page may shorten the signal transmission time between the communication test unit 20 and the specific server.

FIG. 2 is a reference view illustrating a header of a request signal according to an exemplary embodiment of the present invention.

The request signal may be generated by driving a web browser installed at the wireless LAN terminal. This request signal may be a Hyper Text Transfer Protocol (HTTP) based signal for calling a web page provided by the specific server, and may include header information, which includes a URL address of the web page provided by a specific server or an IP address of the specific server. Referring to FIG. 2, a request to access a web address of http://www.RockyDawg.com/HTTP/1.0 is illustrated. The request may be generated and transmitted with a Multipurpose Internet Mail Extension (MIME) header information including a Proxy-Connection field information, a User-Agent field information, an Accept field information, and an Accept-Charset information. The Proxy-Connection field may refer to a type of proxy connection, the User-Agent field may refer to a user agent string of the user agent, the Accept field may refer to content types that may be acceptable, and the Accept-Charset may refer to character sets that may be acceptable. However, aspects of the invention are not limited thereto, such that the header information may include additional fields or different combination of fields.

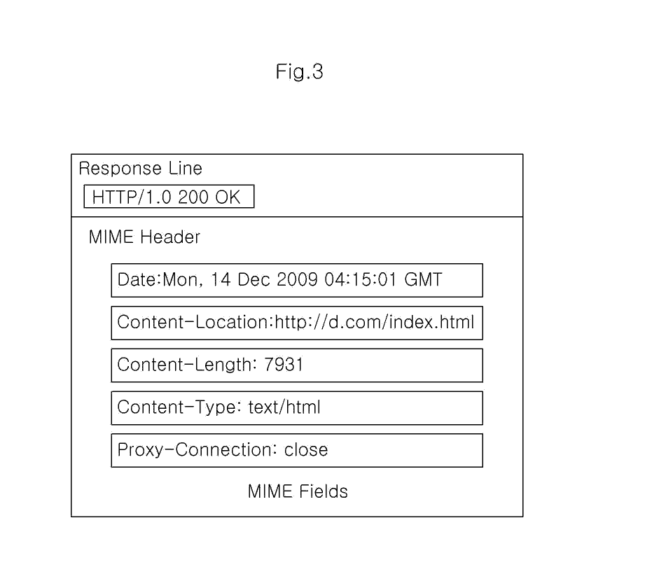

FIG. 3 is a reference view illustrating a header of a response signal according to an exemplary embodiment of the present invention.

The response signal may be generated in response to the request signal. The response signal may be generated by a web server or the like on a network, which may have received the request signal sent from the communication test unit 20, to be transmitted to the communication test unit 20. This response signal may include at least one of an IP address of the web server on the network, which may receive the request signal, a URL address of a web page provided by the web server, data required for implementing the web page, or the like.

In addition, the response signal may include header information, which includes a communication state code associated with a network communication. Referring to FIG. 3 a response line of HTTP/1.0 200 OK is provided. The response signal may include MIME header information including a Date field, Content-Location information, Content-Length information, Content-Type information, and Proxy-Connection information. The Date field may refer to a date and time of the response, the Content location field may refer to an alternate location for the returned data, the Content-Length field may refer to a length of the response body in octets (8-bit bytes), the Content-Type field may refer to the MIME type of the content, and the Proxy-Connection field may refer to a proxy connection status. However, aspects of the invention are not limited thereto, such that the header information may include additional fields or different combination of fields.

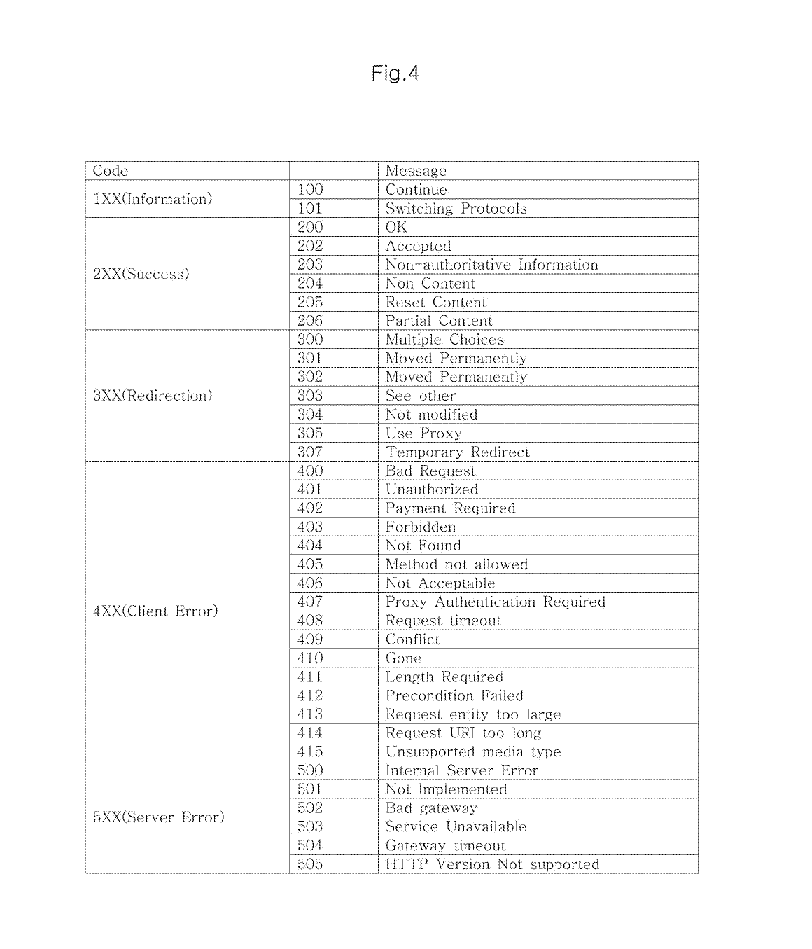

FIG. 4 is a reference view illustrating a communication state code included in the response signal according to an exemplary embodiment of the present invention.

Referring to FIG. 4, the communication state code may be classified into a plurality of categories that may be represented by treble columns. The treble columns include a Series column, a Code column, and a Message column. The Series column includes a 1XX(Information) series or 100 series, a 2XX(Success) series or 200 series, a 3XX(Redirection) series or 300 series, a 4XX(Client Error) series or 400 series, and a 5XX(Server Error) series or 500 series. The 100 series may include codes inclusively between 100 and 199, the 200 series may include codes inclusively between 200 and 299, the 300 series may include codes inclusively between 300 and 399, the 400 series may include codes inclusively between 400 and 499, and the 500 series may include codes inclusively between 500 and 599. The Code column includes various codes corresponding the respective series, for example, codes 100 and 101 correspond to 1XX(Information) or 100 series. The Message column includes various messages corresponding to one or more codes, such as “Conflict” corresponding to code 409 or “Accepted” corresponding to code 202. However, aspects of the invention are not limited thereto, such that additional information columns, code series, codes, and messages may be included.

When the communication state code corresponds to 100 series or 200 series (e.g., 100, 101, 200, 201, 202, 203, 204, 205, and 206), the signal transmission between the wireless LAN terminal serving as a client and the specific server may be normally performed without error. When the communication code corresponds to 300 series (e.g., 300, 301, 302, 303, and 307), the request signal sent from the wireless LAN terminal serving as a client may be redirected to a second server on the network other than the specific server. When the communication code corresponds to 400 series or 500 series (e.g., 400, 401, 402, 403, 404, 405, 406, 407, 408, 409, 410, 411, 412, 413, 414, 415, 500, 501, 502, 503, 504, and 505), normal communication may not be possible since a signal transmission error may occur between the wireless LAN terminal serving as a client and the specific server. Here, the second server may be a web server or the like, which may provide a web page requesting certification information or payment to access the Internet.

Referring to FIG. 1 again, the determination unit 30 may determine an available state of an AP connected to the wireless LAN communication unit 10 by using the test communication result of the communication test unit 20 according to a control of the control unit 50.

More specifically, when the communication test unit 20 performs test communication, the determination unit 30 may determine an available state of the AP according to the communication state code included in the response signal, which may be received through the AP connected to the wireless LAN communication unit 10.

For example, if the communication test unit 20 receives a response signal including a communication state code in the 100 series or 200 series (i.e., at least one of 100, 101, 200, 202, 203, 204, 205, and 206 codes), the determination unit 30 may determine that the available state of the detected AP in the AP scan list is available.

If the communication test unit 20 receives a response signal including a communication state code in the 300 series (i.e., 300, 301, 302, 303, 304, 305, 307), the determination unit 30 may determine that the available state of the AP connected to the wireless LAN communication unit 10 is suspicious or not secure.

If the communication test unit 20 receives a response signal including a communication state code in the 400 series or the 500 series, the determination unit 30 may determine that the available state of the AP connected to the wireless LAN communication unit 10 is unavailable.

The available state of the AP may be determined as being available, suspicious, unavailable, or the like and classified as such. However, aspects of the invention are not limited thereto, such that the classification of the available state of the AP may be represented by different descriptors, which may be different from suspicious, available, and unavailable states mentioned above. Further, the available states of the AP may include additional classifications, such as payment required or authentication required. Also, the available state of the AP may be represented by a combination of available states and by using a combination of classification of available states, such as available and suspicious. Further, additional descriptors may be added to the available state classification to more specifically describe the availability of the APs, such as less suspicious, highly suspicious, available and known, available but unknown, and the like.

In addition, the determination unit 30 may determine an available state of the detected AP by checking whether the IP address or URL address included in a response signal received from the communication test unit 20 corresponds to or is identical to the IP address or URL address included in the request signal sent from the communication test unit 20.

For example, if the IP address or URL address included in a response signal received from the communication test unit 20 corresponds to or is identical to the IP address or URL address included in the request signal sent from the communication test unit 20, the determination unit 30 may determine that the available state of the AP connected to the wireless LAN communication unit 10 is available.

If the IP address or URL address included in a response signal received from the communication test unit 20 is not identical or does not correspond to the IP address or URL address included in the request signal sent from the communication test unit 20, the determination unit 30 may determine that the available state of the AP connected to the wireless LAN communication unit 10 is suspicious or unavailable.

The storage unit 40 may store available state information of one or more APs, which may correspond with AP identification information. The storage unit 40 may store such information in a list as the one shown in Table 1.

For example, when available state information of the AP is provided, the storage unit 40 may store the provided available state information of the AP and corresponding AP identification information, as shown in the first two columns of Table 1. Moreover, the storage unit 40 may further store additional information associated with the AP, such as connectivity information, accessibility information, and access history. Although not illustrated, additional information or notes associated with the AP may be included in the note column of Table 1. The AP identification information may include a Media Access Control (MAC) Address of the AP, an identification code of an AP service provider or the like.

TABLE 1

| AP identification | Available state | |
|---|---|---|
| information | information | Note |
| AP1 | Unavailable | new |
| AP2 | Suspicious | previously connected |
| AP3 | Available | default AP |
| S service provider AP | Suspicious | new |
| K service provider AP | Available | previously connected |
| L service provider AP | Unavailable | new |

The control unit 50 may scan to detect APs within a reference range through the wireless LAN communication unit 10, generate an AP scan list, and display the AP scan list on a screen by the display unit 60. In the AP scan list, APs, which may have basic AP connection information, detected by the performed scan are arranged in a reference order. The basic AP connection information may be obtained during the performed scan. For example, the order of the APs in the scan list may be determined based on various parameters characterizing the APs, which may include at least one of strength of a connection signal received from the APs, prior connection history of the APs, communication information, user customized order and others. The apparatus may enable a user to customize the criteria determining the order of APs in the list. Moreover, the apparatus may enable the user to change the order of the displayed APs on the list according to the user's preference.

If the AP scan list is displayed on the screen, the control unit 50 may determine accessibility or availability of one or more APs included in the AP scan list. More specifically, the control unit 50 may perform a temporary connection to one or more APs in the AP scan list through the wireless LAN communication unit 10 to determine their availability or accessibility.

During the process of performing connection with APs in the AP scan list, the control unit 50 may receive communication information of one or more APs from the wireless LAN communication unit 10 and may reflect the communication information in various ways in the AP scan list displayed on the screen through the display unit 60. The communication information may indicate whether the attempted connection to one or more APs resulted in a success state or a fail status.

In addition, the control unit 50 may change a manner of display of the AP scan list in various ways through the display unit 60 based on the AP communication information. Moreover, the apparatus may periodically refresh the AP scan list including the detected APs by periodically scanning the APs within a reference range of the wireless LAN terminal and updating the connectivity information of the APs. For example, APs that move out of the to reference range of the wireless LAN terminal may be removed from the AP scan list whereas new APs that appear within the reference range of the wireless LAN terminal may be added to the list.

If the wireless LAN communication unit 10 is connected to the AP, the control unit 50 may check to determine whether the connected AP has a previous access history. The control unit 50 may search the storage unit 40 to determine whether the connected AP has a previous access history by using the identification information of the connected AP. The control unit 50 may determine whether the AP has a previous access history by temporarily connecting to the wireless LAN communication unit 10 to determine whether the available state information of the connected AP is stored in the storage unit 40. For example, the storage unit may store an access history list that includes the identity information of one or more APs that have previously connected with the wireless LAN terminal. Further, the access history may also include corresponding availability information, accessibility information, and other information of one or more previously connected APs.

When the connected AP is determined to have a previous access history, the control unit 50 may call or retrieve the available state information of the AP from the storage unit 40 and may reflect or display the available state information in the AP scan list displayed on the screen through the display unit 60.

If the connected AP is determined to have no previous access history, the control unit 50 may control the communication test unit 20 and the determination unit 30 to determine the available state of the AP.

In addition, the control unit 50 may generate available state information associated with the available state of the AP, which may be determined by the determination unit 30. The available state information, which may be matched with the AP identification information of the corresponding AP, may be stored in the storage unit 40. Further, the control unit 50 may generate or update the access history list stored in the storage unit 40 to include availability state and the corresponding information of the scanned APs. The access history list may include temporal information, such as date and time information, of when the AP availability state has been last determined and/or updated.

Moreover, the control unit 50 may display the available state information in various ways in the AP scan list displayed on the screen through the display unit 60. For example, the available state information may be displayed using colors, images, texts, icons, and the like.

The available state information may include at least one of a text, an image, an icon or the like, which may indicate accessibility of an AP. For example, accessibility of an AP may be determined or classified as being available, suspicious, unavailable, or the like. Classification or determination of availability of the AP may be provided in at least one of a text, icon, button, image, or the like. In addition, an image associated with accessibility or availability of an AP may be provided as a thumbnail image of a web page, which may be called when the communication test unit 20 performs test communication. For example, if a Google® webpage is successfully called during the test communication, a thumbnail image of a Google® webpage may be displayed. However, if an authentication page is called during the test communication, a thumbnail image of the authentication page may be displayed.

In addition, the control unit 50 may change the AP scan list displayed on the screen in various ways through the display unit 60 based on the available state information of the AP. For example, the control unit 50 may display the AP rows in the AP scan list displayed on the screen with different background colors through the display unit 60 by reflecting the available state information of each AP. More specifically, AP rows corresponding to available APs may be displayed in green, AP rows corresponding to available but suspicious APs may be displayed in red, and AP rows corresponding to unavailable or obstructed access to APs may be displayed in black. In addition, the control unit 50 may selectively delete or preserve each AP row in the AP scan list based on the available state information of one or more APs. However, aspects of the invention are not limited thereto, such that an AP in the AP scan list may be represented as a row, column, icon, or the like.

Moreover, the apparatus may periodically refresh the AP scan list by updating at least one of availability, connectivity, and accessibility information of the APs included in the AP scan list.

The display unit 60 may display the AP scan list on a screen according to the control of the control unit 50.

When displaying the AP scan list on the screen, the display unit 60 may display at least one of basic connection information, communication information, and available state information of the APs corresponding to one or more AP rows in the AP scan list.

Further, according aspects of the invention, the wireless LAN terminal may connect to an AP that is determined to be available automatically according to a reference criteria or rule. For example, the wireless LAN terminal may be configured to automatically connect to an available AP with the strongest signal or the longest previous access history. Moreover, the respective criteria or rule for choosing the AP with which the wireless LAN terminal automatically attempts a connection may be customized by a user. For example, a user may provide one or more preferred APs, such that when the AP scan list includes the preferred APs the wireless LAN terminal may attempt an automatic connection with.

Further, a method for identifying one or more available or accessible APs of a wireless LAN terminal according to exemplary embodiments of the present disclosure will be described more below in detail.

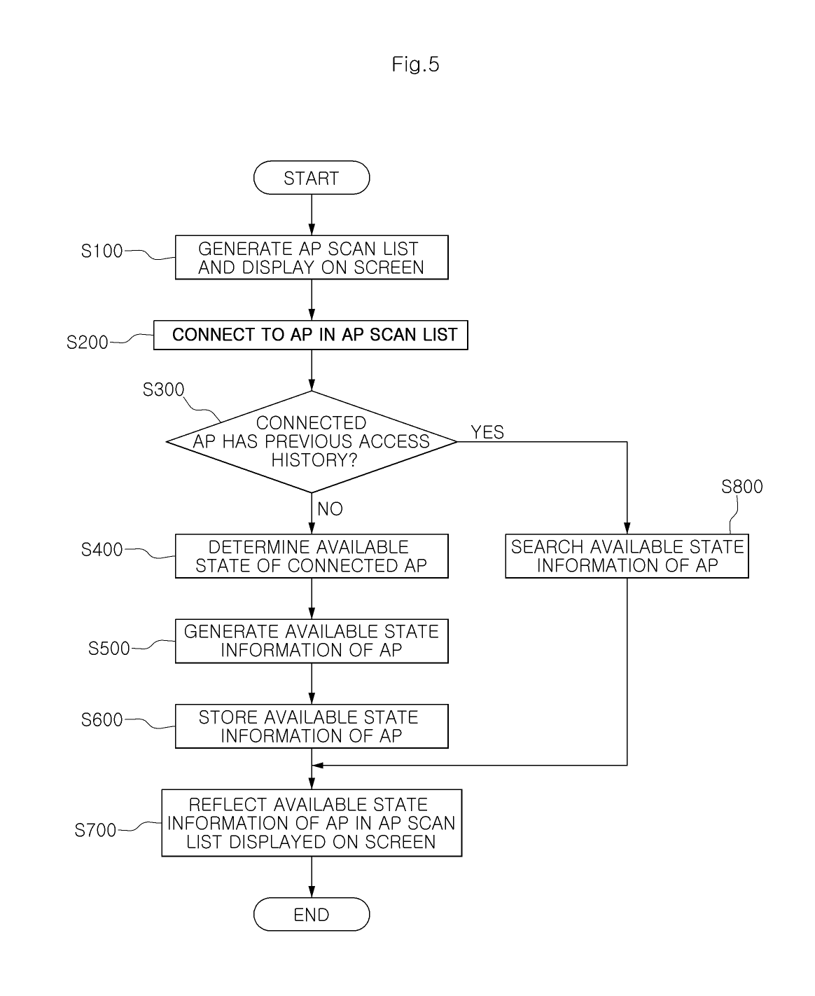

FIG. 5 is a flowchart illustrating a method for scanning an AP in a wireless LAN terminal according to an exemplary embodiment of the present invention.

In operation S100, the wireless LAN terminal scans to detect APs located within a reference distance from the wireless LAN terminal to generate an AP scan list. The generated AP scan list is displayed on a screen of the wireless LAN terminal.

In the AP scan list displayed on the screen, AP rows may be arranged in a reference order.

In operation S200, the wireless LAN terminal attempts to temporarily connect to the APs included in the AP scan list in a reference order.

Further, the wireless LAN terminal may reflect or display communication information of the AP based on the attempted access to the respective APs in the AP scan list displayed on the screen in operation S100. More specifically, the wireless LAN terminal may display a text or other indicator to indicate whether the attempted access to the respective APs was successful or unsuccessful.

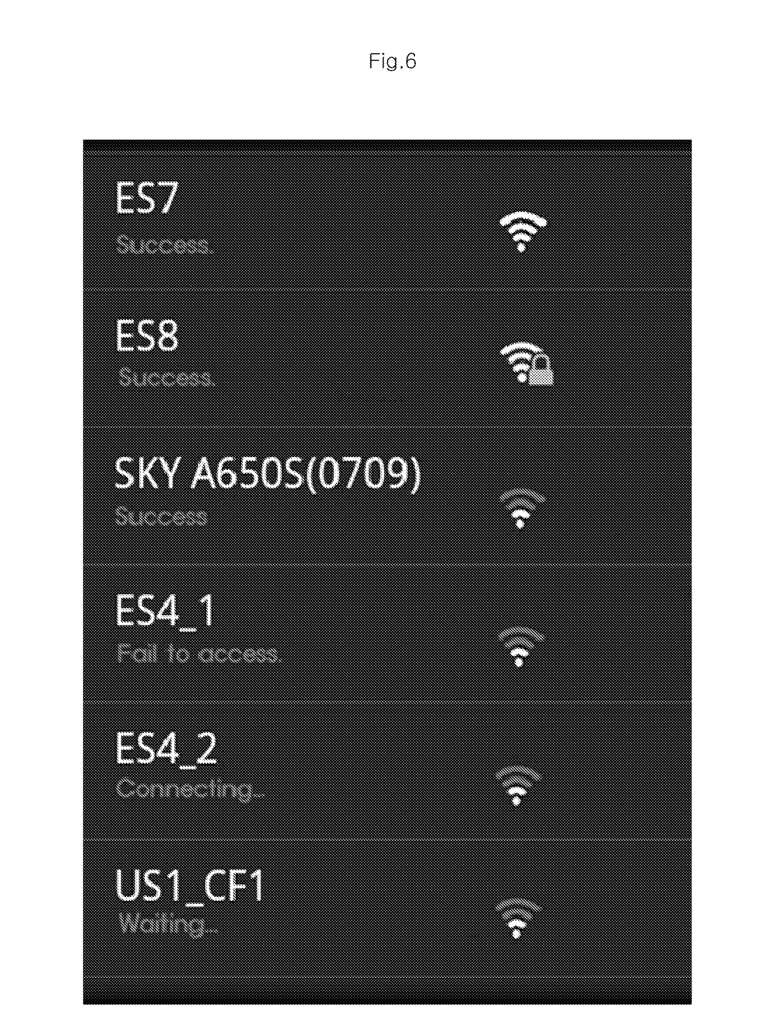

FIG. 6 provides AP scan lists with available state information of APs included therein according to exemplary embodiments of the present invention.

Referring to FIG. 6, result or status of attempted access may be indicated by text description, such as ‘Success’, ‘Fail to access’, ‘Connecting’, or ‘Waiting’.

In operation S300, the wireless LAN terminal determines whether the to successfully accessed AP has a previous access history. However, aspects of the invention are not limited thereto, such that the wireless LAN terminal may also determine previous access history of other APs.

More specifically, the wireless LAN terminal may determine whether an AP has a previous access history based on whether the available state information of the connected AP is stored in an internal storage unit of the wireless LAN terminal.

Further in operation S300, if the wireless LAN terminal determines that the AP has no previous access history, in operation S400, the wireless LAN terminal determines an available state of the connected AP.

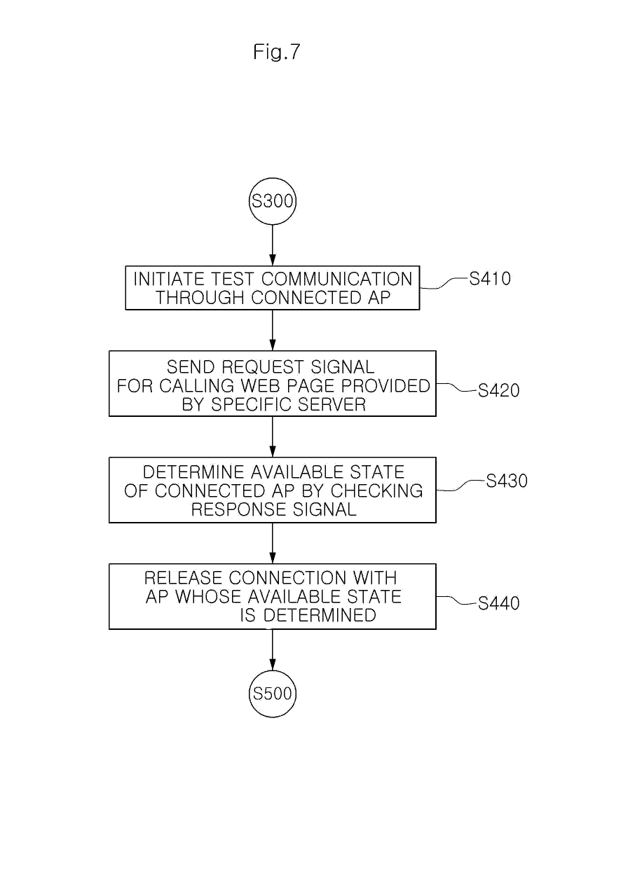

Operation S400 will be described in more detail below with reference to FIG. 7. In operation S410, the wireless LAN terminal initiates a test communication through the connected AP.

In operation S420, the wireless LAN terminal sends a request signal for calling a web page provided by a specific server through the connected AP.

The request signal may include at least one of a URL address of the web page, an IP address of the specific server providing the web page, or the like.

In operation S430, the wireless LAN terminal determines the available state of the connected AP based on the response signal received through the connected AP.

The response signal may include at least one of a communication state code representing a communication state, data used to implement the web page provided by the web server, which has sent the response signal, an IP address of the server, which has sent the response signal, and a URL address of the server provided by the web server.

The wireless LAN terminal determines the available state of the AP according to the communication state code included in the response signal received through the connected AP. The available state of the AP may be classified or determined as, without limitation, available, suspicious, unavailable, or the like.

Further, in operation S430, the wireless LAN terminal may determine the available state of the connected AP based on whether the IP address or URL address included in the response signal is identical or corresponds to the IP address or URL address included in the request signal.

In operation S440, the wireless LAN terminal releases or terminates the connection with the AP whose available state is determined and proceeds to operation S500.

Referring back to FIG. 5, in operation S500, the wireless LAN terminal generates available state information corresponding to the determined available state of the AP.

The available state information may include at least one of a text, an image, an icon or the like, which may represent or indicate the available state of the AP. Referring to FIG. 7, a web address of the web page called in operation S420 and operation S430 may be provided along with the available state of the AP as available state information. The available state may indicate whether the AP is, without limitation, available, suspicious, unavailable, or the like. Further, a thumbnail image of a web page called in operation S420 and operation S430 may be also be provided as part of the available state information to represent or indicate the available state of the AP.

In operation S600, the wireless LAN terminal stores the generated AP available state information in the internal storage unit.

In operation 700, the wireless LAN terminal reflects or provides the AP available state information generated in operation S500 on the AP scan list.

Further, although it is not illustrated, the method of FIG. 5 may be repeated for additional APs included in the AP scan list. The method may be performed for every AP or a reference number of APs. More specifically, once the wireless LAN terminal terminates a temporary connection with a first AP, the wireless LAN terminal may establish a temporary connection with a second AP of which available state is unknown.

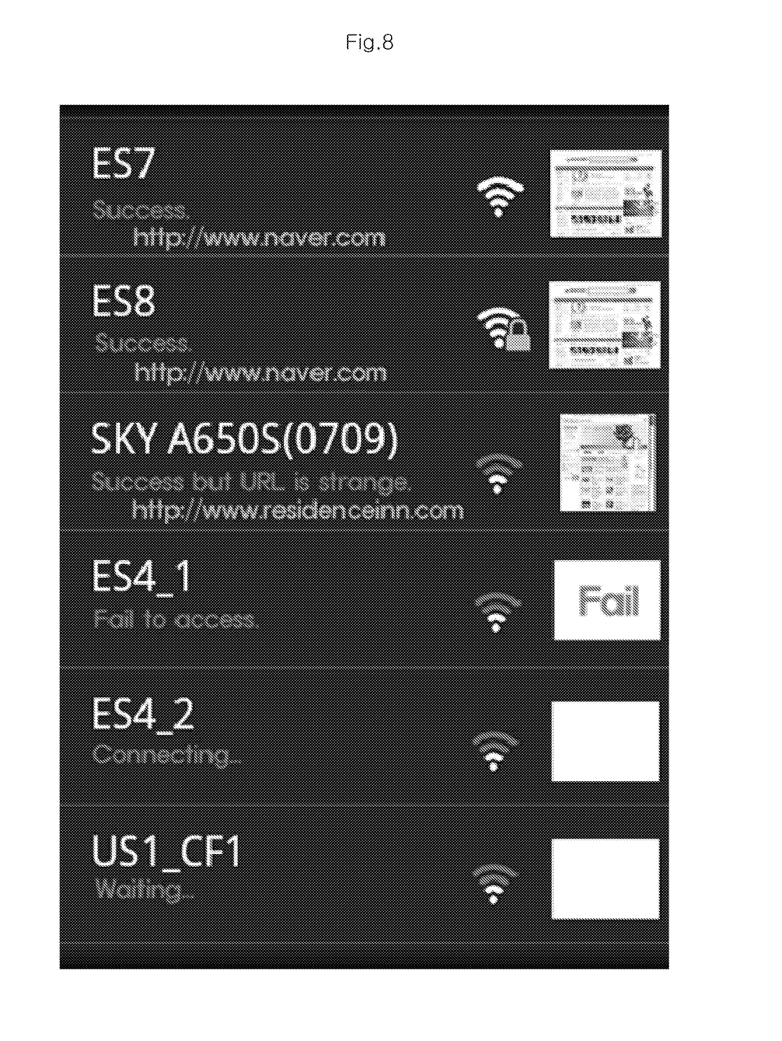

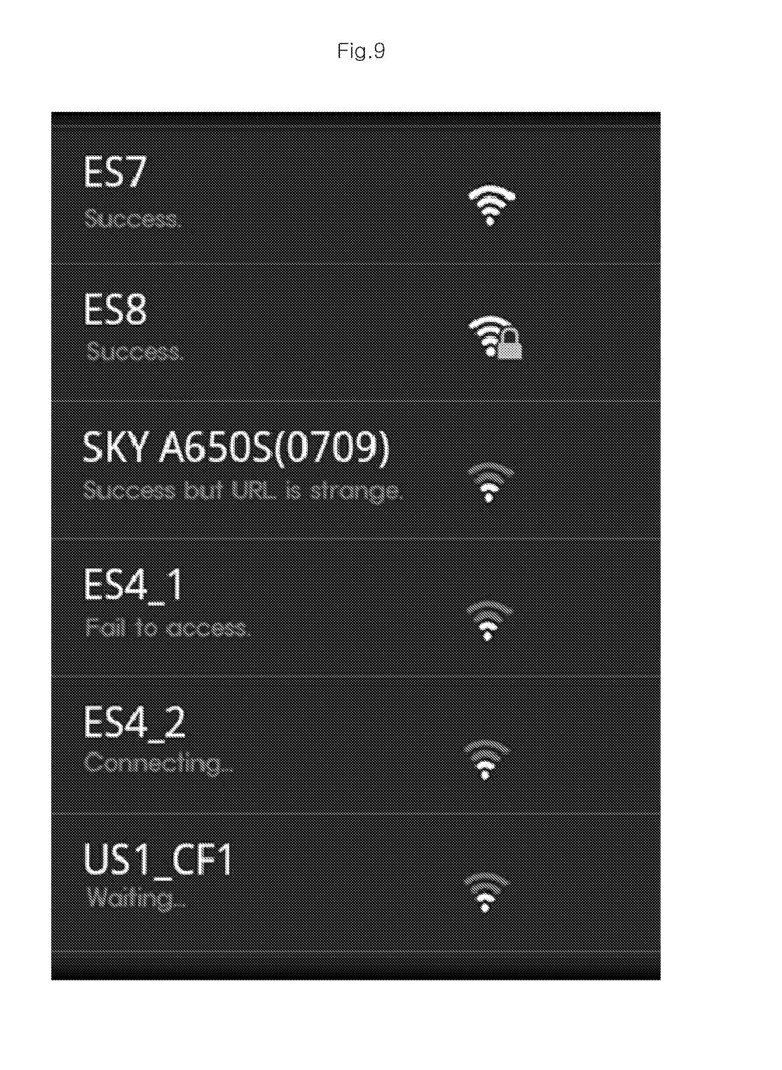

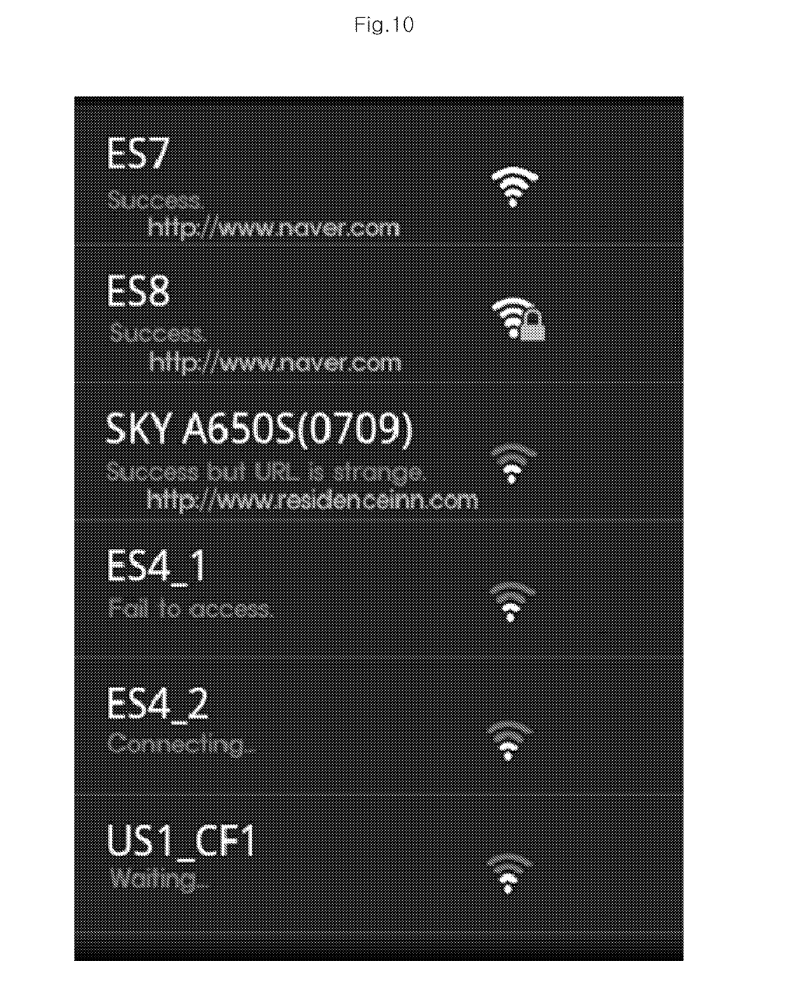

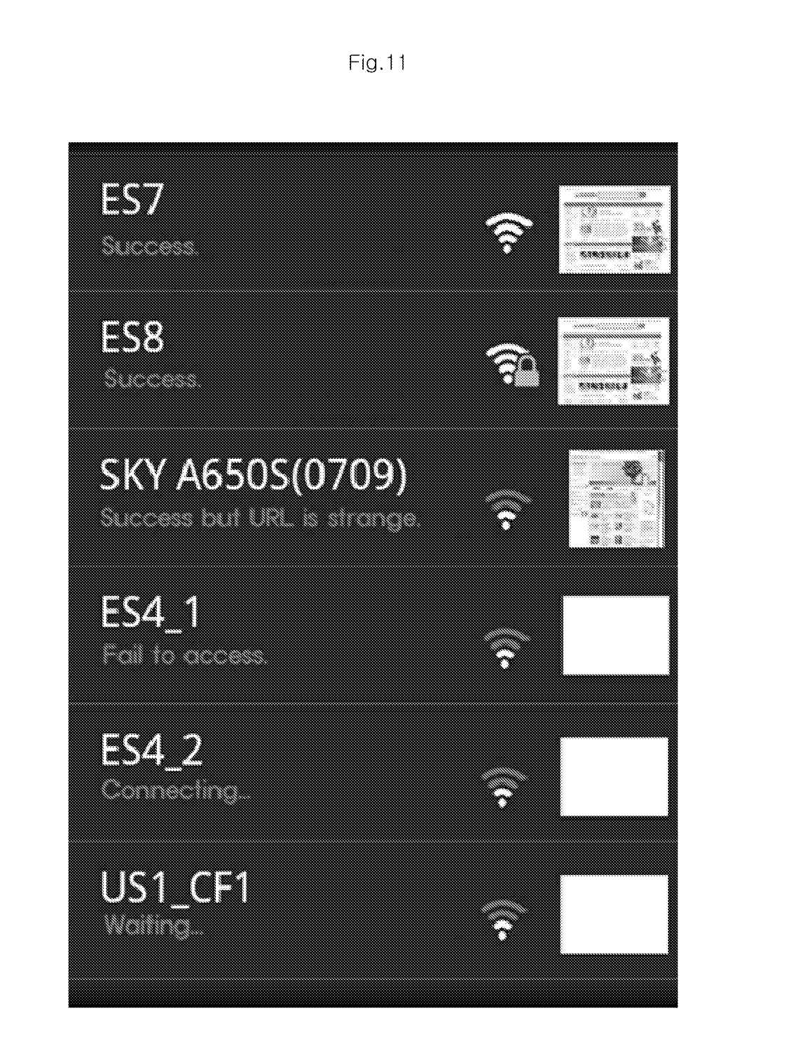

FIG. 8, FIG. 9, FIG. 10, and FIG. 11 provides AP scan lists with available state information of APs included therein according to exemplary embodiments of the present invention.

In each AP row of the AP scan list displayed on the screen of the wireless LAN terminal, the AP basic connection information, the communication information, and the available state information may be displayed as a combination of various forms, such as texts, images and icons, as shown in FIG. 8.

In addition, in each AP row of the AP scan list displayed on the screen of the wireless LAN terminal, texts or icons indicating available state information may be displayed. Referring to FIG. 9, available state information of ‘Success’, ‘Success but URL is strange)’, ‘Fail to access’, ‘Connecting’, and ‘Waiting’ are displayed for the APs included in the AP scan list.

In addition, in each AP row of the AP scan list displayed on the screen of the wireless LAN terminal, web address of a web page called may be displayed as the AP available state information, as shown in FIG. 10.

In addition, in each AP row of the AP scan list displayed on the screen of the wireless LAN terminal, a thumbnail image including a web page called may be displayed as part of the AP available state information, as shown in FIG. 11.

Further, the wireless LAN terminal may change the AP scan list displayed on the screen in various ways through a display unit according to the AP available state information.

For example, the wireless LAN terminal may display one or more AP rows in the AP scan list displayed on the screen in operation S100 to have different background colors according to the AP available state information. An AP row where the available state of the AP determined to be available may be displayed with a green background, an AP row corresponding to an AP that is determined to be suspicious may be displayed with a red background, and an AP row corresponding to an AP that is determined to be unavailable may be displayed with a black background.

In addition, the wireless LAN terminal may selectively delete or preserve to include one or more APs that were initially detected and included in the AP scan list according to the AP available state information.

Further, if the wireless LAN terminal determines that an AP in the AP scan list has a previous access history in operation S300, the wireless LAN terminal search to obtain the available state information of the connected AP, which may be stored in an internal storage unit of the wireless LAN terminal, in operation S800. Operation S700 may be performed by using the obtained or determined AP available state information.

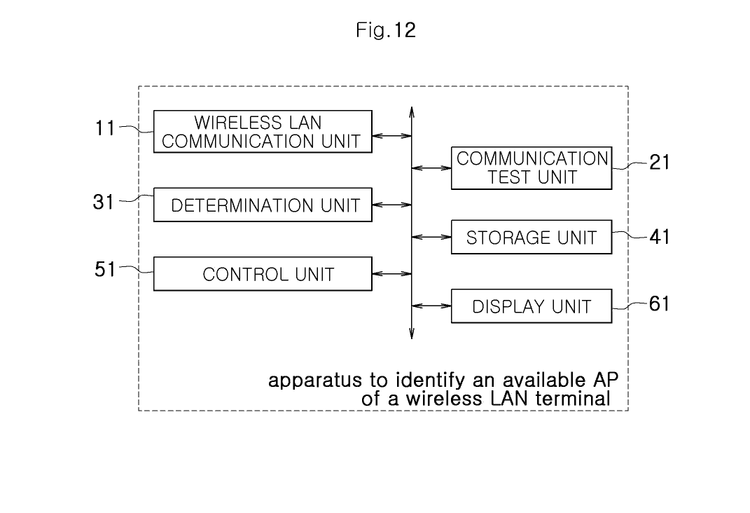

FIG. 12 is a block diagram illustrating an apparatus to identify an available AP of a wireless LAN terminal according to an exemplary embodiment of the present invention.

An apparatus to scan one or more APs of a wireless LAN terminal according to an exemplary embodiment of the present disclosure includes a wireless LAN communication unit 11, a communication test unit 21, a determination unit 31, a storage unit 41, a control unit 51, and a display unit 61.

The wireless LAN communication unit 11, the storage unit 41, the control unit 51 and the display unit 61 may be configured to have similar or the same technical features and configurations as the wireless LAN communication unit 10, the storage unit 40, the control unit 50 and the display unit 60 of FIG. 1. Accordingly, detailed descriptions thereof are omitted herein.

The communication test unit 21 may perform a Packet Internet Grouper (PING) test communication with a specific server on a network through the AP connected to the wireless LAN communication unit 11 according to the control of the control unit 51. The PING communication may refer to a communication method for checking or testing whether an IP datagram can reach a specific server connected to the Internet using a Transmission Control Protocol (TCP) or Internet Protocol (IP).

In addition, the communication test unit 21 may store an IP address of the specific server or the like in an internal memory region to perform the PING test communication with the specific server.

For example, the specific server may be a web server that has one or more of the following properties: allows ordinary connection through the network, enables high-rate distributed data processing, has a large-capacity data storage space, is capable of bearing a large amount of communication traffics, and the server is secure.

When performing the PING test communication with a specific server, the communication test unit 21 may transmits or receives at least one of a request signal and a response signal to/from the specific server through the AP connected to the wireless LAN communication unit 11.

More specifically, when performing the PING test communication with a specific server, the communication test unit 21 may send a plurality of request signals to the specific server through the AP connected to the wireless LAN communication unit 11. Further, the communication test unit 21 may receive a response signal for each request signal. For example, the request signal may be an Internet Control Message Protocol (ICMP) echo request signal, which may be used to check or determine whether the communication is normal. In addition, the response signal may be an ICMP echo response signal, which may be used to check whether the communication is normal. The ICMP may be a protocol, which may indicate abnormality of communication that may occur during IP packet processing under a TCP/IP based communication environment. Further, the ICMP may be used when an operating system of a network terminal receives an error message, such as “Requested Service is not Available” or the like.

The determination unit 31 may determine the available state of the AP connected to the wireless LAN communication unit 11 by using the PING test communication result of the communication test unit 21 according to the control of the control unit 51.

More specifically, when the communication test unit 21 performs PING test communication, the determination unit 31 may determine the available state of the AP by comparing the number of response signals received through the AP connected to the wireless LAN communication unit 11 with the number of request signals sent from the communication test unit 21.

For example, when the communication test unit 21 performs a PING test communication, if at least one response signal is received through the AP connected to the wireless LAN communication unit 11, the determination unit 31 may determine that the available state of the AP connected to the wireless LAN communication unit 11 is either available or suspicious.

When the number of response signals received through the AP connected to the wireless LAN communication unit 11 is identical or corresponds to the number of request signals, the determination unit 31 may determine that the available state of the AP connected to the wireless LAN communication unit 11 is available. Further, when the number of response signals received through the AP connected to the wireless LAN communication unit 11 is smaller than the number of request signals, the state of the AP connected to the wireless LAN communication unit 11 may be determined as suspicious.

In addition, when the communication test unit 21 performs a test communication and if no response signal is received through the AP connected to the wireless LAN communication unit 11, the determination unit 31 may determine that the state of the AP connected to the wireless LAN communication unit 11 is unavailable.

More specifically, the available state of the AP may be classified or determined as available, suspicious, unavailable, or the like.

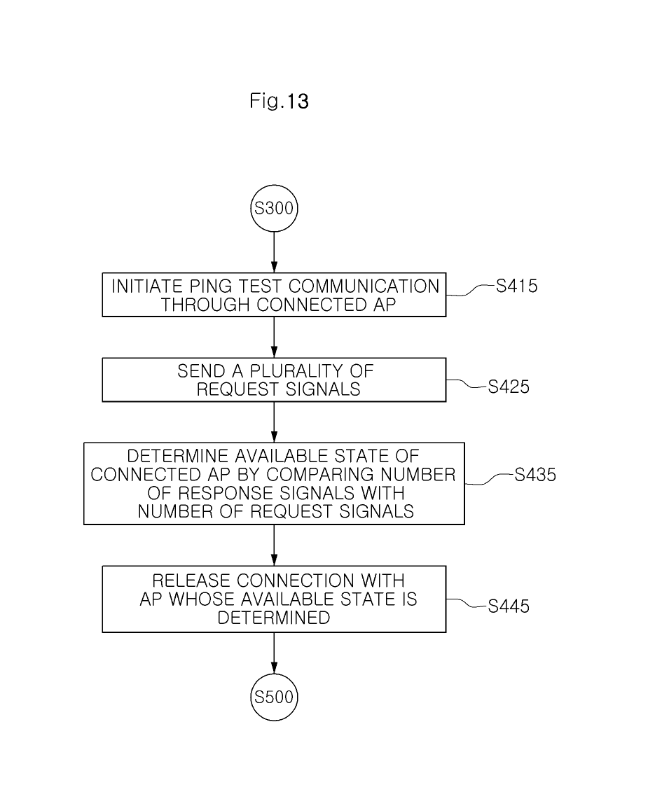

A method for scanning an AP of a wireless LAN terminal will be described below with reference to FIG. 13.

FIG. 13 is a flowchart illustrating an available state determining procedure of FIG. 5 according to an exemplary embodiment of the present invention.

In operation S415, the wireless LAN terminal initiates a PING test communication through the connected AP.

In operation S425, the wireless LAN terminal sends a plurality of request signals through the connected AP to a specific server.

The request signals may include an IP address of the specific server or the like.

In operation S435, the wireless LAN terminal determines the available state of the to connected AP by comparing the number of response signals received through the connected AP with the number of request signals sent in operation S425.

More specifically, in operation S435, when the number of response signals received through the connected AP is similar or identical to the number of request signals, the wireless LAN terminal may determine that the state of the connected AP is available. In addition, when the number of response signals received through the connected AP is smaller than the number of request signals, the state of the connected AP may be determined as suspicious. Moreover, if no response is received through the connected AP, the state of the connected AP may be determined as unavailable.

Further, in operation S435, the wireless LAN terminal may also determine the available state of the connected AP based on whether the IP address included in the response signal received through the connected AP is identical or corresponds to the IP address included in the request signal sent in operation S425.

If the available state of the AP is determined in operation S435, the wireless LAN terminal releases or terminates the connection to the AP whose available state is determined.

If the available state of the connected AP is determined in S400, the method proceeds to operation S500 of FIG. 5, in which the wireless LAN terminal generates available state information for representing the determined available state of the AP.

In one or more AP rows of the AP scan list displayed on the screen of the wireless LAN terminal, the AP basic connection information, the communication information and the available state information may be displayed as a combination of various forms such as texts, images and icons.

In addition, in one or more AP rows of the AP scan list displayed on the screen of the wireless LAN terminal, texts, images, or icons indicating available state information as available, suspicious, and ‘unavailable may be displayed. For example, one of more AP rows of the AP scan list may provide text description of ‘Success’, ‘Successful but URL is strange’, and ‘Fail to access’. However, aspects of the invention are not limited thereto, such that available state information may be described with different descriptors.

Further, the wireless LAN terminal may change the AP scan list displayed on the screen in various ways through the display unit based on the AP available state information.

For example, the wireless LAN terminal may display the AP rows in the AP scan list displayed on the screen to have different background colors by reflecting the AP available state information.

In addition, the wireless LAN terminal may selectively delete or preserve each AP row in the AP scan list displayed on the screen by reflecting or displaying the AP available state information.

Further, when the wireless LAN terminal determines that the connected AP has a previous access history, the wireless LAN terminal searches the available state information of the connected AP, stored in the internal storage unit. The available state information of APs in the AP scan list may be displayed using the searched AP available state information.

According to exemplary embodiments of the present invention, the wireless LAN terminal scans an AP located within a reference proximity from a location of the wireless LAN terminal, determines available state of the respective AP, and displays the AP in an AP scan list on a screen of the wireless LAN terminal. Further, the available state of the scanned AP may be displayed together with the accessible AP and other associated information, such that a user may select an AP for accessing the wireless LAN more conveniently.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An apparatus to identify an available access point (AP), the apparatus comprising:
a communication unit to detect one or more APs located within a reference proximity from the apparatus;
a determination unit to determine an available state of the detected AP; and
a display unit to display an AP scan list comprising the available state of the accessible AP.

2. The apparatus of claim 1, further comprising:
a communication test unit to perform a test communication with a connected AP,
wherein the communication unit connects to at least one of the detected APs, and the determination unit determines the available state of the AP using the results of the test communication.

3. The apparatus of claim 2, wherein the communication test unit transmits a request signal through the AP to a server, receives a response signal comprising a communication code through the AP from the server, and determines the available state of the AP based on the communication state code.

4. The apparatus of claim 2, wherein the communication test unit performs a Packet Internet Group (PING) test communication with a server through the AP, and the determination unit determines the available state of the AP by using the result of the PING test communication.

5. The apparatus of claim 4, wherein the communication test unit determines the available state of the AP by comparing a number of response signals received through the AP with a number of request signals sent from the communication test unit.

6. The apparatus of claim 1, further comprising:
a storage unit to store access history of at least one of the detected APs,
wherein the determination unit determines the available state of the AP based on the access history.

7. The apparatus of claim 6, wherein the determination unit compares information of the AP with the access history stored in the storage unit to determine the available state of the AP.

8. The apparatus of claim 2, wherein the AP scan list displays at least one of a web address and internet protocol (IP) address corresponding to the test communication.

9. The apparatus of claim 2, wherein the AP scan list displays an image of a webpage corresponding to a test communication.

10. The apparatus of claim 1, wherein the AP scan list is displayed in color based on the available state of the AP.

11. A method for identifying an available access point (AP) of a wireless local area network (LAN) terminal, the method comprising:
detecting APs located within a reference proximity of the wireless LAN terminal;
determining an available state of at least one of the detected APs; and
displaying an AP scan list comprising the available state of the AP.

12. The method of claim 11, further comprising:
connecting to at least one of the detected APs;
performing a test communication with the connected AP; and
determining the available state of the connected AP using the results of the test communication.

13. The method of claim 12, wherein the performing the test communication comprises:
transmitting a request signal through the AP to a server;
receiving a response signal comprising a communication state code through the AP from the server; and
determining the available state of the AP based on the communication state code.

14. The method of claim 11, further comprising:
performing a Packet Internet Group (PING) test communication with a server through the AP; and
determining the available state of the AP by using the result of the PING test communication.

15. The method of claim 11, further comprising:
determining whether the AP has an access history; and
determining the available state of the AP based on the access history.

16. The method of claim 15, wherein the determining the available state of an AP comprises:
comparing information of the AP with the access history stored in a storage unit of the wireless LAN terminal.

17. The method of claim 12, wherein the AP scan list displays at least one of a web address and internet protocol (IP) address corresponding to the test communication.

18. The method of claim 12, wherein the AP scan list displays an image of a webpage corresponding to a test communication.

19. The method of claim 11, wherein listing order of the AP scan list is prioritized based in part to the available state of the AP.

20. A method for identifying an available access point (AP) of a wireless local area network (LAN) terminal, the method comprising:
detecting APs located within a reference proximity of the wireless LAN terminal;
connecting to an AP among the detected APs;
transmitting a test communication to the AP;
determining an available state of the AP based on the test communication;
terminating the connection with the AP; and
displaying an AP scan list comprising the available state of the AP.
